(19) United States
(12) Patent Application Publication
(10) Pub. No.: US 2004/0066726 A1
(43) Pub. Date: Apr. 8, 2004

(54) Enclosure for a flash memory hard disk

(76) Inventor: Andrew Chiang, Taipei Hsien (TW)

Correspondence Address: Rabin & Berdo, P.C., Suite 500, 1101 14th Street, Washington, DC, 20005, US

(21) Appl. No.: 10/265,701

(22) Filed: Oct. 8, 2002

(51) Int. Cl. G11B 33/02

(52) U.S. Cl. 369/75.1

(57) ABSTRACT

An enclosure for a flash memory hard disk includes a body with a longitudinally defined receiving hole for receiving therein the flash memory hard disk and a radially defined side hole in communication with the receiving hole, a first cover pivotally connected to the body to selectively cover the receiving hole and a lock module received in the side hole for selectively locking the flash memory hard disk in the body.

### BACKGROUND OF THE INVENTION

1. Field of the Invention

The present invention relates to an enclosure for a flash memory hard disk, and more particularly to an enclosure to detachably receive therein the flash memory hard disk to provide protection to the flash memory hard disk from damage.

2. Description of Related Art

A flash memory hard disk has been invented to the market to adapt to the universal serial bus (USB). The flash memory hard disk is a light-weight, compact, data carrier, which has a size equal to only one half of a standard cigarette lighter and is able to be hooked to the port of the USB to perform data transforming. The flash memory hard disk is much more convenient than the conventional diskette.

Although the flash memory hard disk is convenient, the flash memory hard disk is fragile. Without any protection, the flash memory hard disk is easily damaged by any kind of pressure or weight. Therefore, even though the flash memory hard disk has high performance appreciation, the fragility of the flash memory hard disk causes the flash memory hard disk not to be that popular.

To overcome the shortcomings, the present invention tends to provide an improved enclosure to mitigate and obviate the aforementioned problems.

### SUMMARY OF THE INVENTION

The primary objective of the present invention is to provide an improved enclosure for the flash memory hard disk to protect the flash memory hard disk from damage.

Another objective of the present invention is to provide a lock module attached to the enclosure to provide a positioning effect to the flash memory hard disk in the enclosure.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the enclosure of the present invention;

FIG. 2 is an exploded perspective view of the enclosure of the present invention;

FIG. 3 is a schematic side plan view of the enclosure with partial in section showing the positioning of the lock module to the flash memory hard disk;

FIG. 4 is a schematic side plan view of the enclosure with partial in section showing the release of the flash memory hard disk by the lock module; and

FIGS. 5 and 6 are schematic views showing another embodiment of the lock module.

### DETAILED DESCRIPTION OF THE PREFERRED EMBODIMENT

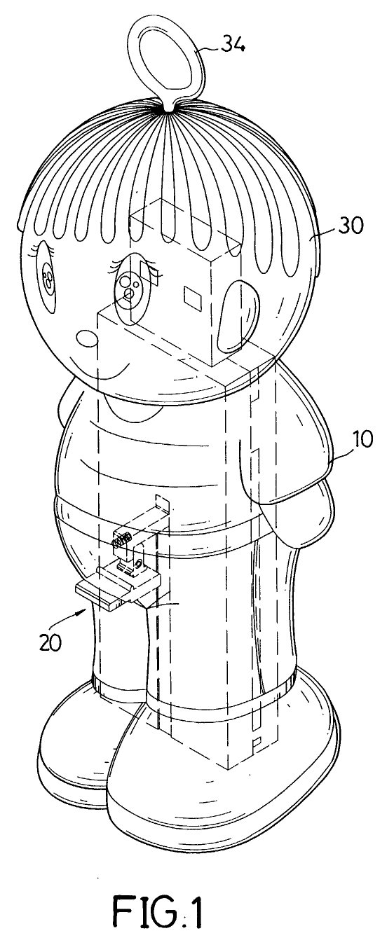

With reference to FIG. 1, the enclosure for a flash memory hard disk and in accordance with the present invention has a body (10), a lock module (20) and a cover (30), wherein in this preferred embodiment, the body (10) is constructed as the body of a doll and the cover (30) is constructed as the head of the doll. A hook (34) may be provided on top of the cover (30) so that the user is able to hang the enclosure to a wall for easy access.

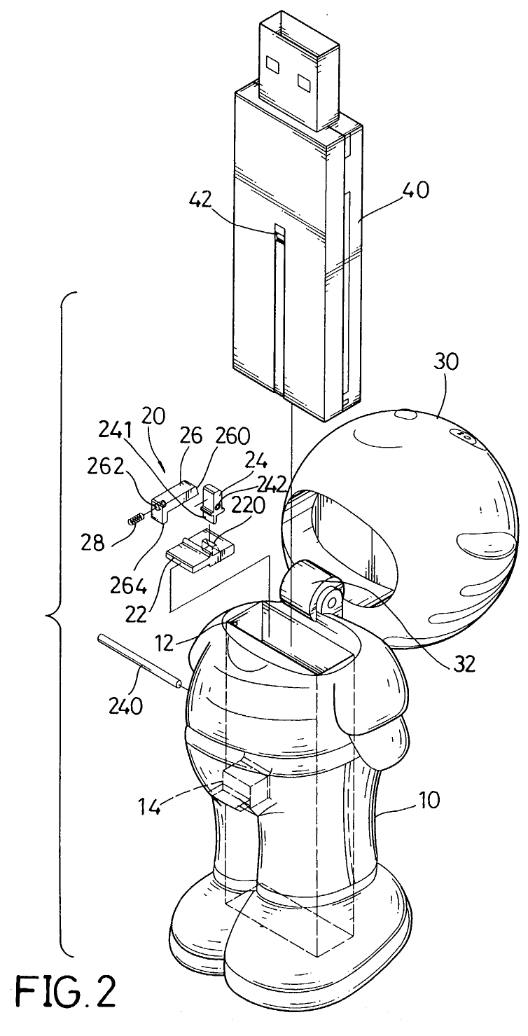

With reference to FIG. 2, the cover (30) is pivotally connected to the body (10) by a pivotal joint (32) which is conventional in the art and is not the focus of the invention so that detailed description of the pivotal joint (32) is omitted. It is noted that a limiting recess (42) is defined in a side face of the flash memory hard disk (40).

The body (10) has a longitudinally defined receiving hole (12) and a radially defined side hole (14) in communication with the receiving hole (12).

The lock module (20) includes a sliding plate (22), a driven plate (24) and a lock plate (26).

The sliding plate (22) has a recess (220) defined in a mediate portion of a top face of the sliding plate (22). The driven plate (24) has a first end and a second end. A narrowed edge (241) is formed on the first end of the driven plate (24). A pivot hole (242) is defined through the driven plate (24) to correspond to a pivot shaft (240).

The lock plate (26) has a first end and a second end. The first end of the lock plate (26) has an inclined face (260) so that the first end is configured as a wedge. The second end of the lock plate (26) has a spring hole (262) defined to receive therein a spring (28). Furthermore, a stop (264) is formed on a bottom face of the lock plate (26) to correspond to the second end of the driven plate (24).

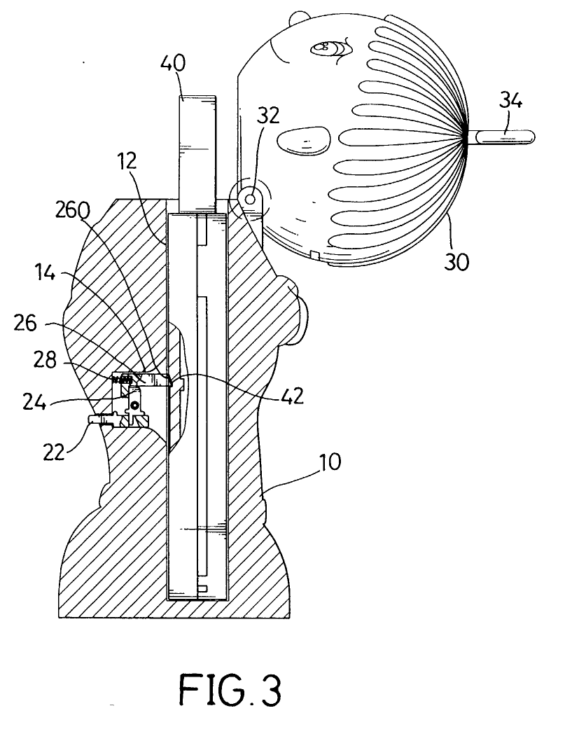

With reference to FIG. 3, when the lock module (20) is to be assembled in the body (10), the lock module (20) is received in the side hole (14) with the first end of the sliding plate (22) protruding out of the body (10) from the side hole (14). The driven plate (24) is pivotally received in the side hole (14) of the body (10) by the pivot shaft (240) abutting opposite sides in the side hole (14) and extending through the pivot hole (242) of the driven plate (24) while the narrowed edge (241) of the driven plate (24) is received in the recess (220). The stop (264) engages with the second end of the driven plate (24) and the spring (28) is received in the spring hole (262) with its free end extending but of the spring hole (262) to abut a side face of the side hole (14).

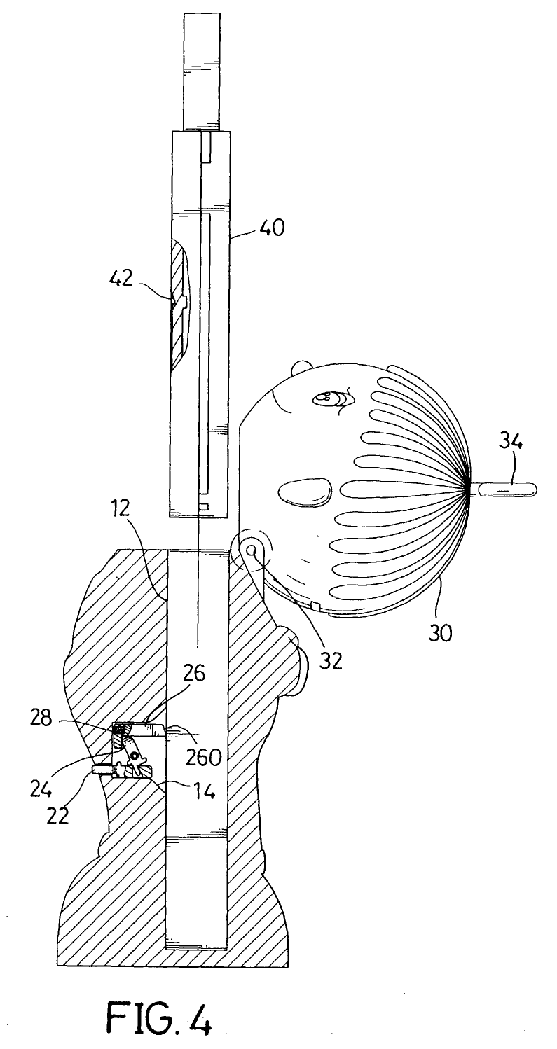

With reference to FIG. 4 and still taking FIG. 3 for reference, when the flash memory hard disk (40) is received in the receiving hole (12), the inclined face (260) of the lock plate (26) extends out of the side hole (14) by the spring (28) and into the receiving hole (12) to abut a side face defining the limiting recess (42). Therefore, the flash memory hard disk (40) is securely received in the enclosure with the cover (30) closed to cover the receiving hole (12).

However, when the flash memory hard disk (40) is to be removed from the enclosure of the present invention, the cover (30) is first removed. Then, the user presses the protruding first end of the sliding plate (22) inward the side hole (14) to drive the first end of the driven plate (24) to move in the recess (220), which triggers the second end of the driven plate (24) to move the lock plate (26) in the side hole (14) to release the engagement with the side face of the limiting recess (42). After the flash memory hard disk (40) is released by the lock plate (26), the user is then able to easily retract the flash memory hard disk (40).

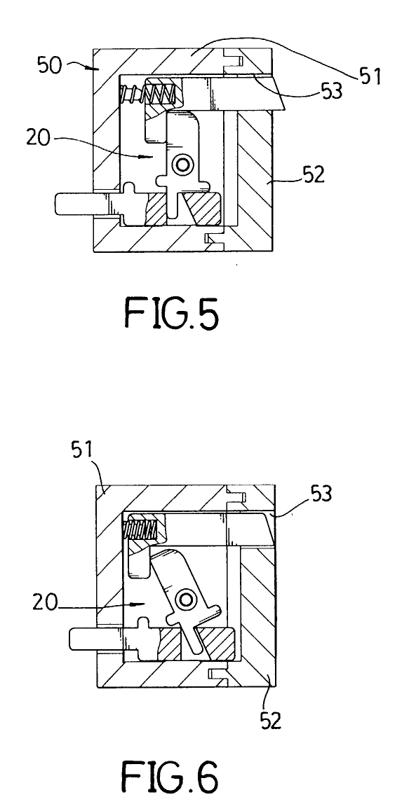

With reference to FIGS. 5 and 6, a casing (50) with a cover (51) and a hollow body (52) pivotally connected to a side of the cover (51) may be provided to receive therein the lock module (20). The hollow body (52) has an extension hole (53) defined in a side face of the body (52) to correspond to the limiting recess (42) of the flash memory hard disk (40).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An enclosure for a flash memory hard disk, the enclosure comprising:
a body with a longitudinally defined receiving hole for receiving therein the flash memory hard disk and a radially defined side hole in communication with the receiving hole;
a first cover pivotally connected to the body to selectively cover the receiving hole; and
a lock module received in the side hole for selectively locking the flash memory hard disk in the body.

2. The enclosure as claimed in claim 1, wherein the lock module includes:
a sliding plate provided with a recess defined in a mediate portion of the sliding plate, a first end and a second end, the first end extending out of the body from the side hole;
a driven plate pivotally received in the side plate and having a first end and a second end, the driven plate being provided with a narrowed edge formed on the first end to correspond to the recess of the sliding plate; and
a lock plate movably received in the side hole and having a stop formed on a bottom face of the lock plate to engage with the second end of the driven plate,
whereby movement of the sliding plate triggers the driven plate to pivot so that the lock plate selectively extends into the receiving hole to adapt to abut a side face of the flash memory hard disk to limit the flash memory hard disk.

3. The enclosure as claimed in claim 2, wherein the driven plate has a pivot hole defined through the driven plate to correspond to a pivot shaft extending through the pivot hole to support the driven plate to pivot in the side hole.

4. The enclosure as claimed in claim 3, wherein the lock plate has a first end and a second end, the first end of the lock plate is formed with an inclined face adapted to correspond to the side face of the flash memory hard disk, the second end of the lock plate has a spring hole defined to receive therein a spring so that the spring is able to provide a recoil force to the lock plate after the lock plate is driven by the driven plate.

5. The enclosure as claimed in claim 4 further comprising a casing to receive therein the lock module, the casing having a second cover and a hollow body pivotally connected to the cover and having an extension hole to correspond to the lock plate.

6. The enclosure as claimed in claim 5 further comprising a hook formed on top of the first cover.
